(19) United States
(12) Patent Application Publication
(10) Pub. No.: US 2014/0165714 A1
(43) Pub. Date: Jun. 19, 2014

(54) TRANSMISSION GASKET WITH SENSORS

(71) Applicant: GM Global Technology Operations LLC, Detroit, MI (US)

(72) Inventors: Paul A. Piorkowski, Milford, MI (US); Kenneth K. Lang, Saline, MI (US); Douglas R. Verner, Sterling Heights, MI (US); John L. Dietz, Novi, MI (US)

(73) Assignee: GM Global Technology Operations LLC, Detroit, MI (US)

(21) Appl. No.: 14/057,576

(22) Filed: Oct. 18, 2013

Related U.S. Application Data
(60) Provisional application No. 61/738,194, filed on Dec. 17, 2012.

(51) Int. Cl. G01M 13/02

(52) U.S. Cl. CPC G01M 13/02
USPC 73/115.02

(57) ABSTRACT

A gasket, spacer plate or separator plate for a motor vehicle transmission includes one or more integrated sensors. Such sensors can measure the pressure, flow rate, temperature, as well as any other desire performance characteristic, of the hydraulic fluid in the transmission. The sensors may be mounted on ports in the gasket, spacer plate or separator plate and/or the sensors can be microelectromechanical sensors (MEMS).

### CROSS-REFERENCE TO RELATED APPLICATION

This application claims the benefit of U.S. Provisional Patent Application No. 61/738,194, filed on Dec. 17, 2012, the entire contents of which are incorporated herein by reference.

### FIELD

The present disclosure relates to motor vehicle transmissions. More specifically, the present disclosure relates to a transmission gasket, spacer plate or separator plate with one or more sensors.

### BACKGROUND

The statements in this section merely provide background information related to the present disclosure and may or may not constitute prior art.

Typical motor vehicle transmissions convert the power from an engine output shaft to a drive shaft. In general, an automatic transmission operates on fluid mechanics, and therefore contains numerous fluid passageways and valves for controlling the flow of transmission fluid through the transmission. The valves are typically mounted in or on a valve body within the transmission case. Specifically, control valve assemblies for motor vehicle transmissions have a multicomponent valve body in which a plurality of valve elements are installed. Interconnecting passages or “worm tracks” are formed in the valve body structures to direct fluid between the valve elements and the transmission devices to be controlled. A gasket, spacer plate or separator plate is secured between adjacent valve body components or structures to prevent undesirable fluid flow between the “worm tracks” of adjacent components. Openings are formed in the separator plates to conduct fluid between “worm tracks”, when desired.

To monitor the performance of the transmission, discrete sensors have been employed to measure, for example, the pressure of the hydraulic fluid in the transmission. The use of such discrete sensors is costly since the implementation of these sensors in transmissions is labor intensive. Accordingly, it is desirable to integrate various types of sensors in the gasket, spacer plate or separator plate.

### SUMMARY

A gasket, spacer plate or separator plate for a motor vehicle transmission includes one or more integrated sensors. Such sensors can measure the pressure, flow rate, temperature, strain or load, as well as any other desire performance characteristic, of the hydraulic fluid in the transmission. The sensors may be mounted on ports in the gasket, spacer plate or separator plate and/or the sensors can be microelectromechanical sensors (MEMS).

Further features, advantages and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way. The components in the figures are not necessarily to scale, emphasis instead being placed upon illustrating the principles of the invention. Moreover, in the figures, like reference numerals designate corresponding parts throughout the views. In the drawings:

FIG. 1 is an expanded perspective view of a gasket, spacer plate or separator plate with a valve body for a motor vehicle transmission in accordance with the principles of the present invention;

FIG. 1A is a close up view of the region 1A of FIG. 1; and

FIG. 2 is a partial close-up view of a gasket, spacer plate or separator plate in accordance with the principles of the present invention.

### DETAILED DESCRIPTION

The following description is merely exemplary in nature and is not intended to limit the present disclosure, application or uses.

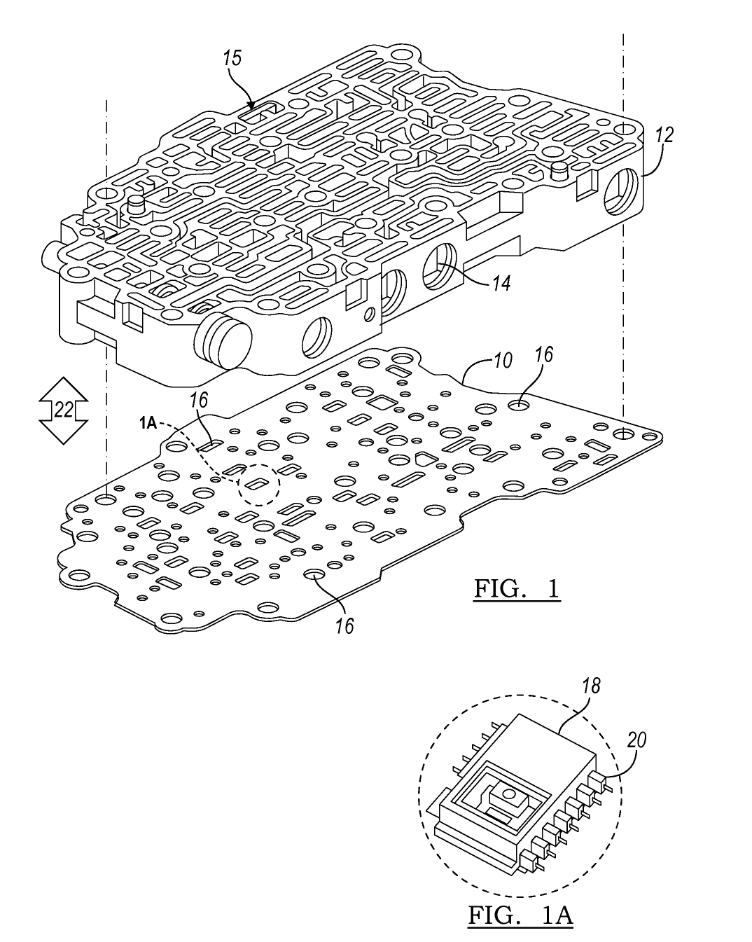

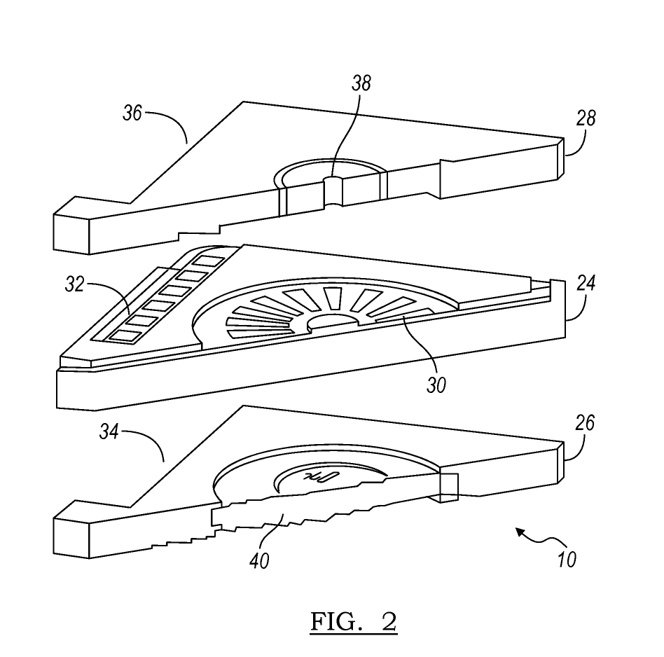

Referring now to the drawings, a gasket, spacer plate or separator plate embodying the principles of the present invention is illustrated in FIGS. 1 and 2 and designated at 10. As shown in FIG. 1, the gasket, spacer plate or separator plate is shown in combination with a valve body 12. The valve body 12 may have a plurality of valve elements. Interconnecting passages or worm tracks 15 are formed in the valve body structure to direct fluid between the valve elements and the transmission devices to be controlled. The gasket, spacer plate or separator plate 10 is secured to the valve body 12 components or structures to prevent undesirable fluid flow between the worm tracks of adjacent components, such as for example, another valve body or a transmission case. Openings 16, however, are formed in the gasket, spacer plate or separator plate to conduct fluid between worm tracks, when desired, of adjacent components. Note that the gasket, spacer plate or separator plate can include orifices to enable communication between the valve body 12 and the transmission.

The valve body 12 can be made from any suitable material, such as, for example, aluminum, steel or cast iron. The valve body 12 may include openings 14 on the side of the valve body 12 to provide access for hydraulic fluid to flow to and from the sides of the valve body. Hydraulic fluid can also flow from the bottom of the gasket, spacer plate or separator plate through openings 16 into the valve body 12 or from the valve body into the openings 16 of the gasket, spacer plate or separator plate as indicated by the double arrow 22.

The gasket, spacer plate or separator plate can be made of a composite material, plastic, a sheet of metal or any other suitable material and can include fluid passages allowing for the alternative position of the sensor. In various implementations the gasket, spacer plate or separator plate includes one or more sensors 18 (FIG. 1A). The sensor 18 can be attached to the gasket, spacer plate or separator plate substrate by soldering a set of connectors 20 to corresponding pads on the substrate. The sensor 18 can measure pressure, temperature, flow rate or any other desired performance characteristic of the hydraulic fluid in the transmission. The sensors 18 may communicate with each other or they may communicated with a control unit independently of each other. The sensors 18 can be independent components that are attached to the gasket, spacer plate or separator plate substrate as mentioned above or they may be integrated into the gasket, spacer plate or separator plate 10 as describe below.

Turning now to FIG. 2, there is shown a portion of the gasket, spacer plate or separator plate 10 with an integrated sensor 30. In this arrangement, the gasket, spacer plate or separator plate includes a substrate 24 sandwiched between two outer gasket, spacer plate or separator plate layers 26 and 28. The three layers 24, 26, 28 can be bonded together by any suitable process, such as, employed, for example, in the production of integrated circuits.

In addition to the sensor 30, the substrate 24 includes a set of electrical connectors 32 that communicate electrically with the sensor 30. Access to the electrical connectors 32 can be provided by a cutaway or notched region 36 of the outer layer 38 and/or by a cutaway or notched region 34 of the outer layer 26.

The electrical connectors 32 enable the sensor 30 to transmit and receive signals from another sensor or control unit. For example, the connectors 20 of the aforementioned sensor 28 can be connected to the electrical connectors 32 by soldering the connectors 20 to the electrical connectors 32 or by any other suitable connection process. Depending upon the implementation of the gasket, spacer plate or separator plate 10, the electrical connectors 32 can be connected to corresponding connectors of another integrated sensor in the substrate 24, for example, by wires that are soldered or attached to the respective electrical connectors integrated into the substrate 24. The electrical connectors 32 can provide a connection point for the sensor 30 to communicate with one or more sensors or control units that are not integrated into the substrate 24, for example, one or more sensors or control units that reside outside of the transmission.

In particular implementations, one or both layers 26, 28 may include an orifice or opening 38 that communicates with the sensor 30. Hence, the orifice or opening 38 would provide physical communication between, for example, the hydraulic fluid in the transmission and the sensor 30. Additionally or alternatively, one or both layers 26, 28 may include a pad 40 that communicates with the sensor 30 physically, electrically or thermally to transmit information to the sensor outside of the layers 26, 28. Again the sensor 30 can be employed to measure any number of performance characteristics of the transmission, such as, for example, pressure, temperature and flow rate. There may be only one sensor 30 or there may be two or more sensors 30 distributed over the substrate 24 of the gasket, spacer plate or separator plate 10. The sensor 30 can be any suitable integrated sensor, such as, for example, microelectromechanical sensors. Additional layers may be added to increase the robustness of the sensor 30 and/or to increase the functionality of the sensor 30.

The gasket, spacer plate or separator plate with one or more sensors 30 is not limited to the implementations described above. The sensors 30 can be employed to measure any desired characteristic. For example, these sensors can be strain energy and forces sensors that can indicate a precursor to catastrophic failures or measure a clamp load that can indicate if a part was assembled correctly. Accordingly, these sensors can be employed on many types of gaskets, spacer plates or separator plates and, therefore, are not limited to the measurement of performance characteristics in transmission valve bodies.

The description of the invention is merely exemplary in nature and variations that do not depart from the gist of the invention are intended to be within the scope of the invention. Such variations are not to be regarded as a departure from the spirit and scope of the invention.

What is claimed is:

1. A measuring apparatus for a motor vehicle transmission comprising:
a plate mountable to a component of the transmission; and
at least one sensor connected to the plate, wherein the sensor measures one or more performance characteristics associated with the transmission.

2. The apparatus of claim 1 wherein the component is a valve body.

3. The apparatus of claim 2 wherein the plate includes a plurality of openings to enable communication of fluid to and from the valve body through the plate.

4. The apparatus of claim 1 wherein the sensor is attached to the plate by soldering electrical connectors on the sensor to pads on the plate.

5. The apparatus of claim 1 wherein the sensor is an integrated sensor in the plate.

6. The apparatus of claim 5 wherein the plate includes a first layer, a second layer and a substrate sandwiched between the first layer and the second layer.

7. The apparatus of claim 6 wherein the sensor is formed in the substrate.

8. The apparatus of claim 7 wherein the substrate includes a set of connectors that communicate electrically with the sensor.

9. The apparatus of claim 7 wherein the sensor is a microelectromechanical sensor.

10. The apparatus of claim 5 wherein at least one of the first layer and the second layer includes a pad that communicates with the sensor physically, electrically or thermally to transmit information to the sensor.

11. The apparatus of claim 1 wherein the one or more performance characteristics is a pressure, a temperature, a fluid flow rate, a strain, a load or combinations thereof.

12. The apparatus of claim 1 wherein the plate is a gasket, spacer plate or separator plate for the transmission.

13. The apparatus of claim 1 wherein the plate is formed of a composite material, a plastic or a metal.

14. A measuring apparatus for a motor vehicle transmission comprising:
a valve body; and
a plate mounted to the valve body, the plate including at least one sensor that measures one or more performance characteristics associated with the transmission.

15. The apparatus of claim 14 wherein the valve body includes worm tracks that direct fluid through the valve body and the plate includes a plurality of openings that communicate fluid to and from the worm tracks.

16. The apparatus of claim 14 wherein the sensor is attached to the plate by soldering electrical connectors on the sensor to pads on the plate.

17. The apparatus of claim 14 wherein the sensor is an integrated sensor in the plate.

18. The apparatus of claim 17 wherein the plate includes a first layer, a second layer and a substrate sandwiched between the first layer and the second layer, and wherein the sensor is formed in the substrate.

19. The apparatus of claim 18 wherein the substrate includes a set of connectors that communicate electrically with the sensor.

20. The apparatus of claim 17 wherein at least one of the layers includes a pad that communicates with the sensor physically, electrically or thermally to transmit information to the sensor.

21. The apparatus of claim 14 wherein the one or more performance characteristics is a pressure, a temperature, a fluid flow rate, a strain, a load or combinations thereof.
